(19) United States
(12) Patent Application Publication
(10) Pub. No.: US 2023/0413040 A1
(43) Pub. Date: Dec. 21, 2023

(54) DATA PROCESSING METHOD, DEVICE, AND STORAGE MEDIUM

(71) Applicant: Beijing Baidu Netcom Science Technology Co., Ltd., Beijing (CN)

(72) Inventor: Tingting GE, Beijing (CN)

(21) Appl. No.: 18/156,601

(22) Filed: Jan. 19, 2023

(30) Foreign Application Priority Data
Jun. 21, 2022 (CN) 202210706657.4

(51) Int. Cl. H04W 12/037; H04L 9/06

(52) U.S. Cl. CPC H04W 12/037; H04L 9/0618

(57) ABSTRACT

Provided are a data processing method and apparatus, a device, and a storage medium. The data processing method includes extracting the original data of a preset field from a to-be-broadcast Bluetooth data packet, where the preset field includes at least one of: a media access control (MAC) address field, a Bluetooth major identifier field, or a Bluetooth minor identifier field; acquiring the validity check value of the to-be-broadcast Bluetooth data packet; encrypting the original data of the preset field by using the validity check value and a Bluetooth key to obtain the target data of the original data, where the target data includes a data ciphertext; and determining an encrypted Bluetooth data packet based on the target data and broadcasting the encrypted Bluetooth data packet.

### CROSS-REFERENCE TO RELATED APPLICATION(S)

This application claims priority to Chinese Patent Application No. 202210706657.4 filed Jun. 21, 2022, the disclosure of which is incorporated herein by reference in its entirety.

### TECHNICAL FIELD

The present disclosure relates to the field of computer technology and, in particular, to the field of wireless communication technology. The present disclosure is applicable to a Bluetooth positioning scenario and specifically relates to a data processing method and apparatus, a device, and a storage medium.

### BACKGROUND

A Bluetooth-based indoor positioning method is one of the most widely used methods in the current market and is also one of positioning methods used for indoor navigation. The technology requires the deployment of a large number of Bluetooth devices (such as Bluetooth beacons) in a positioning field (such as a parking lot). The Bluetooth devices may periodically broadcast Bluetooth data packets. Navigation software in user equipment may acquire the Bluetooth data packets and signal strength values to build a positioning capability. Because of the openness of a Bluetooth broadcast, there is a situation in which competitive products also perform indoor positioning and navigation by acquiring the Bluetooth data packets. Therefore, improvement for this situation is urgently needed.

### SUMMARY

The present disclosure provides a data processing method, a device, and a storage medium.

According to an aspect of the present disclosure, a data processing method is provided. The method includes the steps below.

The original data of a preset field is extracted from a to-be-broadcast Bluetooth data packet. The preset field includes at least one of: a media access control (MAC) address field, a Bluetooth major identifier field, or a Bluetooth minor identifier field.

The validity check value of the to-be-broadcast Bluetooth data packet is acquired.

The original data of the preset field is encrypted by using the validity check value and a Bluetooth key to obtain the target data of the original data. The target data includes a data ciphertext.

An encrypted Bluetooth data packet is determined based on the target data. The encrypted Bluetooth data packet is broadcast.

According to another aspect of the present disclosure, a data processing method is provided. The method includes the steps below.

The encrypted Bluetooth data packet broadcast by a Bluetooth device is received.

The target data of the preset field is extracted from the encrypted Bluetooth data packet. The preset field includes at least one of: a MAC address field, a major field, or a minor field. The target data includes a data ciphertext.

The validity check value of the encrypted Bluetooth data packet is acquired.

The data ciphertext in the target data is decrypted by using the validity check value and the Bluetooth key of the Bluetooth device to obtain the original data of the target data.

A decrypted Bluetooth data packet is determined based on the original data. Positioning processing is performed based on the decrypted Bluetooth data packet.

According to another aspect of the present disclosure, an electronic device is provided. The electronic device includes at least one processor and a memory communicatively connected to the at least one processor.

The memory stores instructions executable by the at least one processor to enable the at least one processor to execute the data processing method according to any embodiment of the present disclosure.

According to another aspect of the present disclosure, a non-transitory computer-readable storage medium is provided. The storage medium stores computer instructions for causing a computer to execute the data processing method according to any embodiment of the present disclosure.

According to another aspect of the present disclosure, a computer program product is provided. The computer program product includes a computer program. When executing the computer program, a processor performs the data processing method according to any embodiment of the present disclosure.

According to the technology of the present disclosure, the problem that a competitive product piggybacks on a deployed Bluetooth device can be solved.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a flowchart of a data processing method according to an embodiment of the present disclosure.

FIG. 2 is a flowchart of another data processing method according to an embodiment of the present disclosure.

FIG. 3 is a flowchart of another data processing method according to an embodiment of the present disclosure.

FIG. 4 is a flowchart of another data processing method according to an embodiment of the present disclosure.

FIG. 5 is a flowchart of another data processing method according to an embodiment of the present disclosure.

FIG. 6 is a flowchart of another data processing method according to an embodiment of the present disclosure.

FIG. 7 is a diagram illustrating the structure of a data processing apparatus according to an embodiment of the present disclosure.

FIG. 8 is a diagram illustrating the structure of another data processing apparatus according to an embodiment of the present disclosure.

FIG. 9 is a block diagram of an electronic device for implementing a data processing method according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

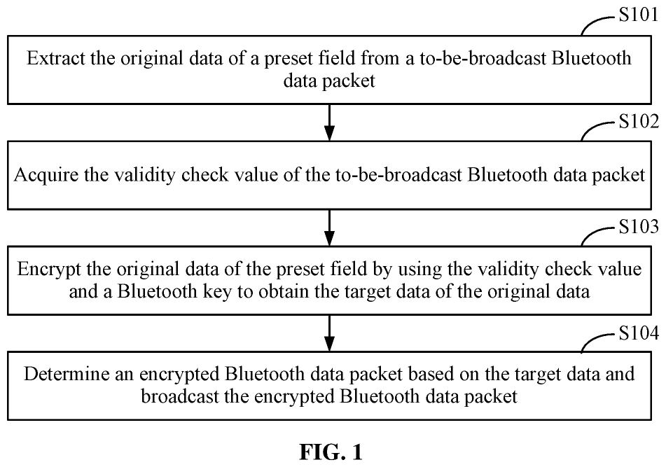

FIG. 1 is a flowchart of a data processing method according to an embodiment of the present disclosure. This method is applicable to the case where a Bluetooth data packet is encrypted in a Bluetooth positioning scenario to prevent a Bluetooth device from being improperly shared. This method may be executed by a data processing apparatus. This apparatus may be performed by software and/or hardware and may be integrated into an electronic device carrying a data processing function, such as a Bluetooth device. As shown in FIG. 1, the data processing method according to this embodiment may include the steps below.

In S101, the original data of a preset field is extracted from a to-be-broadcast Bluetooth data packet.

In this embodiment, the to-be-broadcast Bluetooth data packet is to-be-broadcast Bluetooth data. Optionally, the Bluetooth data packet may include, but is not limited to, a universally unique identifier (UUID) code, data corresponding to a Bluetooth major identifier field, data corresponding to a Bluetooth minor identifier field, and data corresponding to a media access control (MAC) address field. The data corresponding to the major field and the data corresponding to the minor field are used to assist the UUID to make the Bluetooth device unique. For example, the data corresponding to the major field may be the approximate position information of the Bluetooth device, and the data corresponding to the minor field may be the specific position information of the Bluetooth device.

The preset field refers to a field corresponding to the data to be encrypted and decrypted in the Bluetooth data packet. Optionally, the preset field may include at least one of: a MAC address field, a major field, or a minor field. For example, if the operating system corresponding to the positioning application supported by the Bluetooth device is an iOS system, the preset field must include a major field and/or a minor field and may also include a MAC address field. If the operating system corresponding to the positioning application supported by the Bluetooth device is an Android system, the preset field must include a MAC address field and may also include a major field and/or a minor field.

In addition, if the operating system corresponding to the positioning application supported by the Bluetooth device may be the iOS system or the Android system, the preset field may be one or more of the MAC address field, the major field, and the minor field.

The original data refers to data corresponding to the preset field in the Bluetooth data packet. Specifically, the original data refers to data that needs to be encrypted corresponding to the preset field in the Bluetooth data packet.

Specifically, when a broadcast period is reached, the Bluetooth device generates a to-be-broadcast Bluetooth data packet and extracts the original data of the preset field from the to-be-broadcast Bluetooth data packet.

In S102, the validity check value of the to-be-broadcast Bluetooth data packet is acquired.

In this embodiment, the validity check value may be a value or a string having a unique function and can be used to encrypt and decrypt the Bluetooth data packet. For example, the validity check value may be generated based on a random number generation rule. Optionally, the validity check value corresponds to the to-be-broadcast Bluetooth data packet in a one-to-one manner.

In an optional embodiment, after the to-be-broadcast Bluetooth data packet is generated, the Bluetooth device may generate the validity check value of the Bluetooth data packet based on a certain random number generation rule.

In S103, the original data of the preset field is encrypted by using the validity check value and a Bluetooth key to obtain the target data of the original data.

In this embodiment, preset fields are different, and the contents included in the target data of the original data corresponding to the preset fields are different. Further, the target data includes at least a data ciphertext. The data ciphertext is obtained by encrypting part or all of the original data corresponding to the preset field.

Optionally, the validity check value and the Bluetooth key can be used to encrypt part or all of the data in the original data corresponding to the preset field based on a preset encryption algorithm to obtain the data ciphertext. For example, the parameter of the encryption algorithm may be initialized by using the validity check value and the Bluetooth key, and the initialized encryption algorithm may be used to encrypt part or all of the data in the original data corresponding to the preset field to obtain the data ciphertext.

Thereafter, the target data of the original data may be obtained based on the data ciphertext. For example, if all the data of the original data corresponding to the preset field is encrypted, at this time, the data ciphertext may be directly used as the target data of the original data. For another example, if part of the data of the original data corresponding to the preset field is encrypted, at this time, the data ciphertext and the unencrypted data in the original data corresponding to the preset field may be used together as the target data of the original data.

In S104, an encrypted Bluetooth data packet is determined based on the target data. The encrypted Bluetooth data packet is broadcast.

Specifically, the target data of the original data may be used to replace the original data of the preset field in the to-be-broadcast Bluetooth data packet to obtain the encrypted Bluetooth data packet, and the encrypted Bluetooth data packet is broadcast to the outside.

In the technical solutions provided by this embodiment of the present disclosure, the original data of the preset field is extracted from the to-be-broadcast Bluetooth data packet. Thereafter, the validity check value of the to-be-broadcast Bluetooth data packet is acquired. Then, the original data of the preset field is encrypted by using the validity check value and the Bluetooth key to obtain the target data including the data ciphertext. Further, the encrypted Bluetooth data packet may be obtained based on the target data, and the encrypted Bluetooth data packet is broadcast. In the preceding technical solutions, on the premise that the reception of the Bluetooth data packet by a mobile terminal is not affected, the data corresponding to the preset field is encrypted to encrypt the to-be-broadcast Bluetooth data packet. In this manner, the problem that a deployed Bluetooth device is piggybacked on is solved. At the same time, the case where other Bluetooth devices having the same preset field data content as the data content of the deployed Bluetooth device maliciously interferes with a positioning effect can be avoided.

On the basis of the preceding embodiment, in an optional method of the present disclosure, each of the major field and the minor field may include a valid field. Further, the major field may also include a random field, and/or the minor field may also include a random field.

The valid field corresponds to valid data, such as a valid string. The random field corresponds to invalid data, such as a random number or a random string. Further, data corresponding to a random field may be used to determine the validity check value.

It is to be understood that in this embodiment, random fields disposed in the major field and the minor field provide several optional methods for determining the validity check value.

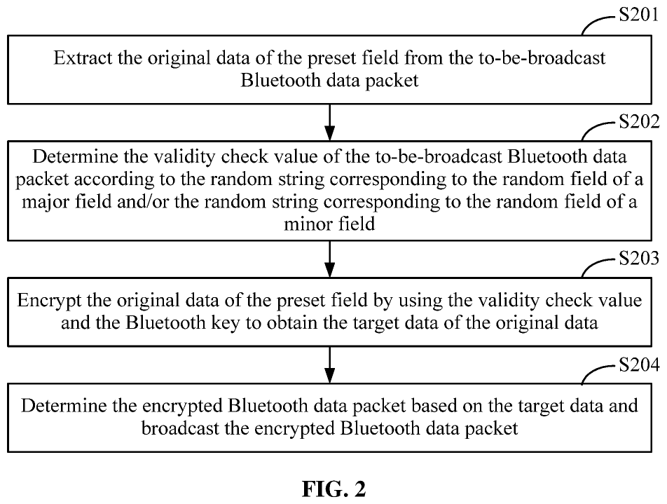

FIG. 2 is a flowchart of another data processing method according to an embodiment of the present disclosure. Based on the preceding embodiment, this embodiment further optimizes the method for the operation of acquiring the validity check value of the to-be-broadcast Bluetooth data packet and provides an optional embodiment. As shown in FIG. 2, the data processing method according to this embodiment may include the steps below.

In S201, the original data of the preset field is extracted from the to-be-broadcast Bluetooth data packet.

The preset field includes at least one of: a MAC address field, a major field, or a minor field.

In S202, the validity check value of the to-be-broadcast Bluetooth data packet is determined according to the random string corresponding to the random field of the major field and/or the random string corresponding to the random field of the minor field.

It is to be noted that the major field and/or the minor field in S202 may be a preset field in S201 or not. Further, in the case where the major field and/or the minor field in S202 is not the preset field in S201, since the to-be-broadcast Bluetooth data packet includes data of the major field and data of the minor field, the data corresponding to the major field and/or the data corresponding to the minor field may also be acquired from the to-be-broadcast Bluetooth data packet.

Optionally, in the case where the major field includes a random field, the validity check value of the to-be-broadcast Bluetooth data packet is determined according to the random string corresponding to the random field of the major field. Specifically, the random string corresponding to the random field of the major field may be used as the validity check value of the to-be-broadcast Bluetooth data packet. For example, the fixed position (such as the last six bits) of the major field is the random field, and the other positions (such as the other bits other than the last six bits) are the valid field, and then part or all of strings are extracted from random strings corresponding to the random field and used as the validity check value of the to-be-broadcast Bluetooth data packet.

Optionally, in the case where the minor field includes a random field, the validity check value of the to-be-broadcast Bluetooth data packet is determined according to the random string corresponding to the random field of the minor field. Specifically, the random string corresponding to the random field of the minor field may be used as the validity check value of the to-be-broadcast Bluetooth data packet. For example, the fixed position (such as the first bit) of the minor field is the random field, and the other positions (such as the other bits other than the first bit) are the valid field, part or all of strings are extracted from random strings corresponding to the random field and used as the validity check value of the to-be-broadcast Bluetooth data packet.

Optionally, in the case where the major field includes a random field, and the minor field includes a random field, the validity check value of the to-be-broadcast Bluetooth data packet is determined according to the random string corresponding to the random field of the major field and/or the random string corresponding to the random field of the minor field. Specifically, a target string is selected from the random string corresponding to the random field of the major field and the random string corresponding to the random field of the minor field. The target string is used as the validity check value of the to-be-broadcast Bluetooth data packet.

For example, part or all of strings are selected from the random strings corresponding to the random field of the major field and used as the target string. Then the target string is used as the validity check value of the to-be-broadcast Bluetooth data packet.

Alternatively, part or all of strings are selected from the random strings corresponding to the random field of the minor field and used as the target string. Then the target string is used as the validity check value of the to-be-broadcast Bluetooth data packet.

Alternatively, part or all of strings may be extracted from the random strings corresponding to the random field of the major field and used as a first string, and part or all of strings are extracted from the random strings corresponding to the random field of the minor field and used as a second string. The first string and the second string are spliced to obtain the target string. Then the target string is used as the validity check value of the to-be-broadcast Bluetooth data packet. For example, a corresponding string is extracted from the random field (such as the last six bits) of the major field and used as the first string, and a corresponding string is extracted from the random field (such as the first bit) of the minor field and used as the second string. Thereafter, the first string and the second string may be spliced based on a certain splicing rule. For example, the first string is added after the second string to obtain the target string. Then the target string is used as the validity check value of the to-be-broadcast Bluetooth data packet.

It is to be understood that the validity check value of the to-be-broadcast Bluetooth data packet is determined in different manners, thereby widening the determination method of the validity check value.

In S203, the original data of the preset field is encrypted by using the validity check value and the Bluetooth key to obtain the target data of the original data.

In S204, the encrypted Bluetooth data packet is determined based on the target data. The encrypted Bluetooth data packet is broadcast.

In the technical solutions provided by this embodiment of the present disclosure, the original data of the preset field is extracted from the to-be-broadcast Bluetooth data packet. Thereafter, the validity check value of the to-be-broadcast Bluetooth data packet is determined according to the random string corresponding to the random field of the major field and/or the random string corresponding to the random field of the minor field. Then, the original data of the preset field is encrypted by using the validity check value and the Bluetooth key to obtain the target data including the data ciphertext. Further, the encrypted Bluetooth data packet may be obtained based on the target data, and the encrypted Bluetooth data packet is broadcast. In the preceding technical solutions, the validity check value is determined based on the random field of the major field and the random field of the minor field. In one aspect, the determination method of the validity check value is widened, and data support is provided for subsequent encryption of the original data of the preset field. In another aspect, the uniqueness of the validity check value is ensured based on the randomness of a random string, thereby increasing the difficulty in cracking the encrypted Bluetooth data packet.

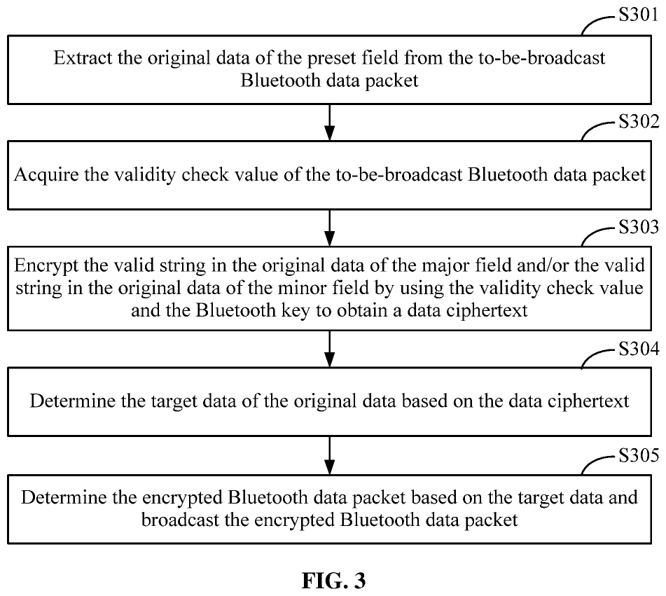

FIG. 3 is a flowchart of another data processing method according to an embodiment of the present disclosure. Based on the preceding embodiments, in the case where the preset field includes a major field and/or a minor field, this embodiment further optimizes the method for the operation of encrypting the original data of the preset field by using the validity check value and the Bluetooth key to obtain the target data of the original data and provides an optical solution. As shown in FIG. 3, the data processing method according to this embodiment may include the steps below.

In S301, the original data of the preset field is extracted from the to-be-broadcast Bluetooth data packet.

The preset field includes at least one of: a MAC address field, a major field, or a minor field.

In S302, the validity check value of the to-be-broadcast Bluetooth data packet is acquired.

In S303, the valid string in the original data of the major field and/or the valid string in the original data of the minor field is encrypted by using the validity check value and the Bluetooth key to obtain the data ciphertext.

In S304, the target data of the original data is determined based on the data ciphertext.

In S305, the encrypted Bluetooth data packet is determined based on the target data. The encrypted Bluetooth data packet is broadcast.

In an embodiment, in the case where the preset field is the major field, and the major field includes a random field, the original data of the major field includes a valid string and a random string, and the valid string is data corresponding to the valid field of the major field.

Alternatively, in the case where the preset field is the major field, and the major field does not include a random field, the original data of the major field is a valid string.

In the two cases, the validity check value and the Bluetooth key may be used to encrypt the valid string in the original data of the major field based on the preset encryption algorithm to obtain the data ciphertext. Thereafter, the data ciphertext is used to replace the valid string in the original data to obtain the target data of the original data. The target data of the original data is used to replace the original data of the major field in the to-be-broadcast Bluetooth data packet to obtain the encrypted Bluetooth data packet, and the encrypted Bluetooth data packet is broadcast to the outside.

In another embodiment, in the case where the preset field is the minor field, and the minor field includes a random field, the original data of the minor field includes a valid string and a random string, and the valid string is data corresponding to the valid field of the minor field.

Alternatively, in the case where the preset field is the minor field and the minor field does not include a random field, the original data of the minor field is a valid string.

In the two cases, the validity check value and the Bluetooth key may be used to encrypt the valid string in the original data of the minor field based on the preset encryption algorithm to obtain the data ciphertext. Thereafter, the data ciphertext is used to replace the valid string in the original data to obtain the target data of the original data. The target data of the original data is used to replace the original data of the minor field in the to-be-broadcast Bluetooth data packet to obtain the encrypted Bluetooth data packet, and the encrypted Bluetooth data packet is broadcast to the outside.

In another embodiment, in the case where the preset field is the major field and the minor field, the major field includes a random field, and the minor field does not include a random field, the original data of the major field includes a valid string and a random string, and the original data of the minor field is a valid string.

Alternatively, in the case where the preset field is the major field and the minor field, the minor field includes a random field, and the major field does not include a random field, the original data of the minor field includes a valid string and a random string, and the original data of the major field is a valid string.

Alternatively, in the case where the preset field is the major field and the minor field, the major field includes a random field, and the minor field includes a random field, the original data of the major field includes a valid string and a random string, and the original data of the minor field includes a valid string and a random string.

In the three cases, the validity check value and the Bluetooth key may be used to encrypt the valid string in the original data of the major field based on the preset encryption algorithm to obtain first encrypted data. The valid string in the original data of the minor field is encrypted to obtain second encrypted data. The first encrypted data and the second encrypted data are used as the data ciphertext.

Thereafter, the target data of the original data may be determined based on the data ciphertext. That is, the first encrypted data is used to replace the valid string in the original data of the major field to obtain the target data of the original data of the major field, and the second encrypted data is used to replace the valid string in the original data of the minor field to obtain the target data of the original data of the minor field. Then, the target data of the original data of the major field and the target data of the original data of the minor field are used to update the to-be-broadcast Bluetooth data packet to obtain the encrypted Bluetooth data packet.

In the technical solutions provided by this embodiment of the present disclosure, the original data of the preset field is extracted from the to-be-broadcast Bluetooth data packet. Thereafter, the validity check value of the to-be-broadcast Bluetooth data packet is acquired. The valid string in the original data of the major field and/or the valid string in the original data of the minor field is encrypted by using the validity check value and the Bluetooth key to obtain the data ciphertext. Then, the target data of the original data is determined based on the data ciphertext. Further, the to-be-broadcast Bluetooth data packet is updated based on the target data to obtain the encrypted Bluetooth data packet. Finally, the encrypted Bluetooth data packet is broadcast. In the preceding technical solutions, the original data of different preset fields is dynamically encrypted, so that the encryption method of the Bluetooth data packet is widened.

On the basis of the preceding embodiment, in an optional implementation of the present disclosure, in the case where the preset field includes a MAC address field, the original data of the preset field may be encrypted by using the validity check value and the Bluetooth key to obtain the target data of the original data in the following manners: The original data of the MAC address field is encrypted by using the validity check value and the Bluetooth key to obtain the data ciphertext; and the target data of the original data is determined based on the data ciphertext.

Specifically, the Bluetooth key and the validity check value may be used to encrypt the original data of the MAC address field based on the preset encryption algorithm to obtain the data ciphertext. Thereafter, the data ciphertext is used to replace the original data of the MAC address field to obtain the target data of the original data.

Further, the target data of the original data is used to replace the original data of the MAC address field in the Bluetooth data packet to obtain the encrypted Bluetooth data packet.

It is to be understood that in this embodiment, the original data of the MAC address field may be encrypted, so that the data encryption method of the Bluetooth data packet is further widened.

On the basis of the preceding embodiment, in an optional method of the present disclosure, in the case where the preset field includes a MAC address field, a major field, and/or a minor field, the validity check value and the Bluetooth key may be used to encrypt the original data of the MAC address field based on the preset encryption algorithm to obtain the data ciphertext. At the same time, the valid string of the major field and/or the valid string of the minor field is encrypted by using the validity check value and the Bluetooth key to obtain the data ciphertext.

Thereafter, the target data of a corresponding field is determined based on the obtained data ciphertext, and the original data of the corresponding field in the to-be-broadcast Bluetooth data packet is updated based on the target data of the corresponding field to obtain the encrypted Bluetooth data packet. The specific process is described in the preceding embodiments, and the details are not repeated here.

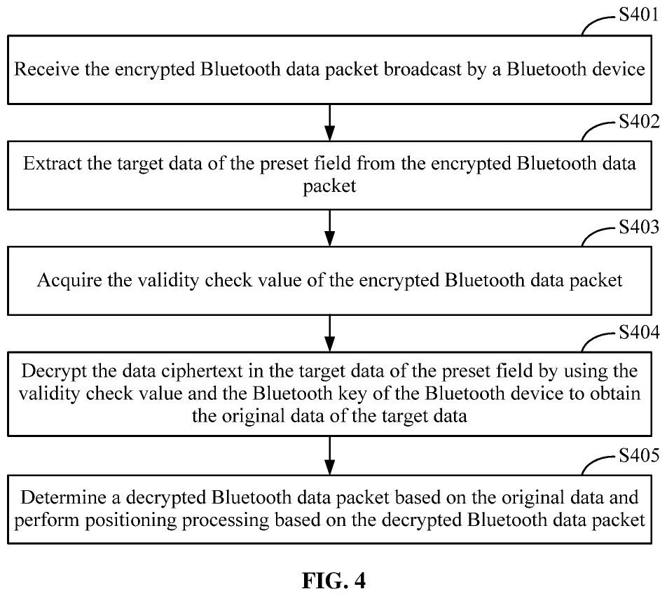

FIG. 4 is a flowchart of another data processing method according to an embodiment of the present disclosure. The method is applicable to how to perform positioning based on the encrypted Bluetooth data packet in the Bluetooth positioning scenario. The encrypted Bluetooth data packet may be obtained by the Bluetooth device based on the data processing method provided in any one of the preceding embodiments. The data processing method provided in this embodiment may be executed by a data processing apparatus. This apparatus may be performed by software and/or hardware and may be integrated into an electronic device carrying a data processing function, such as a mobile terminal. As shown in FIG. 4, the data processing method according to this embodiment may include the steps below.

In S401, the encrypted Bluetooth data packet broadcast by the Bluetooth device is received.

Specifically, the mobile terminal may receive the encrypted Bluetooth data packet broadcast by the Bluetooth device.

In S402, the target data of the preset field is extracted from the encrypted Bluetooth data packet.

In this embodiment, the target data refers to data corresponding to the preset field in the encrypted Bluetooth data packet and may include a data ciphertext. The data ciphertext is obtained by encrypting part or all of the original data corresponding to the preset field. The original data corresponding to the preset field is data that is not encrypted.

Optionally, the preset field includes at least one of: a MAC address field, a major field, or a minor field. For example, the preset field may include at least one of: a MAC address field, a major field, or a minor field. For example, if the operating system corresponding to the positioning application supported by the Bluetooth device is the iOS system, the preset field must include a major field and/or a minor field and may also include a MAC address field. If the operating system corresponding to the positioning application supported by the Bluetooth device is the Android system, the preset field must include a MAC address field and may also include a major field and/or a minor field.

In addition, if the operating system corresponding to the positioning application supported by the Bluetooth device may be the iOS system or the Android system, the preset field may be one or more of the MAC address field, the major field, and the minor field. It is to be noted that the preset field in this embodiment is the same as the preset field in the process in which the Bluetooth device encrypts a to-be-processed Bluetooth data packet.

Specifically, the target data of the preset field may be read from the encrypted Bluetooth data packet.

In S403, the validity check value of the encrypted Bluetooth data packet is acquired.

In this embodiment, the validity check value may be a value or a string having a unique function and may be used to encrypt and decrypt the Bluetooth data packet. For example, the validity check value may be generated based on the random number generation rule. Optionally, the validity check value corresponds to the encrypted Bluetooth data packet in a one-to-one manner.

In an embodiment, the mobile terminal acquires the encrypted Bluetooth data packet in the same manner as the Bluetooth device acquires the to-be-processed Bluetooth data packet. For example, the same random number generation rule as the rule of the Bluetooth device may be used to generate the validity check value of the encrypted Bluetooth data packet. Alternatively, the validity check value of the encrypted Bluetooth data packet is determined according to the random string corresponding to the random field of the major field and/or the random string corresponding to the random field of the minor field.

In S404, the data ciphertext in the target data of the preset field is decrypted by using the validity check value and the Bluetooth key of the Bluetooth device to obtain the original data of the target data.

Optionally, the data ciphertext in the target data of the preset field may be decrypted based on the decryption algorithm corresponding to the Bluetooth device by using the validity check value and the Bluetooth key of the Bluetooth device to obtain the original data of the target data. For example, if all the data of the original data corresponding to the preset field is encrypted to obtain the data ciphertext, the decryption result of the data ciphertext may be directly used as the original data of the target data. For another example, if part of the data of the original data corresponding to the preset field is encrypted to obtain the data ciphertext, at this time, the decryption result of the data ciphertext and the unencrypted data in the target data corresponding to the preset field may be used together as the original data of the target data.

In S405, a decrypted Bluetooth data packet is determined based on the original data. Positioning processing is performed based on the decrypted Bluetooth data packet.

Specifically, the original data of the target data may be used to replace the target data of the preset field in the encrypted Bluetooth data packet to obtain the decrypted Bluetooth data packet. Corresponding positioning processing is performed based on the decrypted Bluetooth data packet.

In the technical solutions provided by this embodiment of the present disclosure, the encrypted Bluetooth data packet broadcast by the Bluetooth device is received. Thereafter, the target data of the preset field is extracted from the encrypted Bluetooth data packet. Then, the validity check value of the encrypted Bluetooth data packet is acquired, and the data ciphertext in the target data of the preset field is decrypted by using the validity check value and the Bluetooth key of the Bluetooth device to obtain the original data of the target data. Further, the decrypted Bluetooth data packet may be obtained based on the original data. Finally, positioning processing is performed based on the decrypted Bluetooth data packet. In the preceding technical solutions, on the premise that the reception of the Bluetooth data packet by the mobile terminal is not affected, the data corresponding to the preset field is encrypted to encrypt the to-be-broadcast Bluetooth data packet. In this manner, the problem that a deployed Bluetooth device is piggybacked on is solved. At the same time, the case where other Bluetooth devices having the same preset field data content as the data content of the deployed Bluetooth device maliciously interferes with the positioning effect can be avoided.

On the basis of the preceding embodiment, in an optional method of the present disclosure, each of the major field and the minor field may include a valid field. Further, the major field may also include a random field, and/or the minor field may also include a random field.

The valid field corresponds to the valid data, such as a valid string. The random field corresponds to the invalid data, such as a random number or a random string. Further, the data corresponding to the random field may be used to determine the validity check value.

It is to be understood that in this embodiment, the random fields disposed in the major field and the minor field provide several optional methods for determining the validity check value.

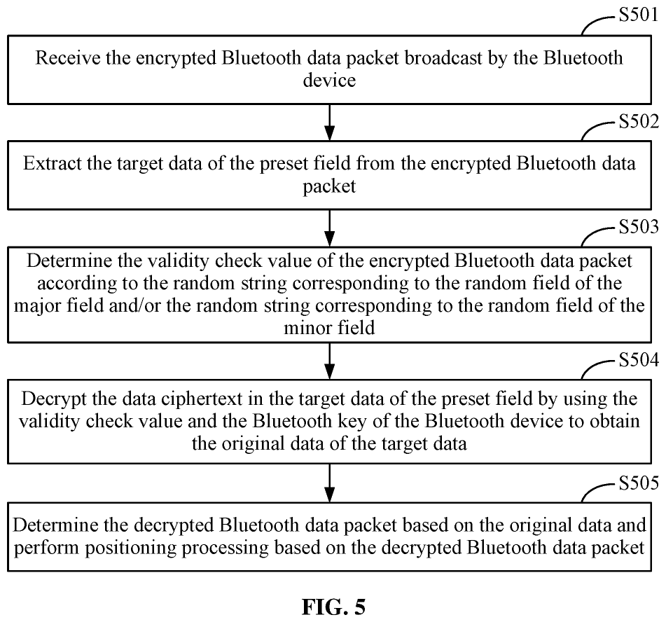

FIG. 5 is a flowchart of another data processing method according to an embodiment of the present disclosure. Based on the preceding embodiments, this embodiment optimizes the method for the operation of acquiring the validity check value of the encrypted Bluetooth data packet and provides an optional embodiment. As shown in FIG. 5, the data processing method according to this embodiment may include the steps below.

In S501, the encrypted Bluetooth data packet broadcast by the Bluetooth device is received.

In S502, the target data of the preset field is extracted from the encrypted Bluetooth data packet.

The preset field includes at least one of: a MAC address field, a major field, or a minor field.

In S503, the validity check value of the encrypted Bluetooth data packet is determined according to the random string corresponding to the random field of the major field and/or the random string corresponding to the random field of the minor field.

It is to be noted that the major field and/or the minor field in S503 may be a preset field in S502 or not. Further, in the case where the major field and/or the minor field in S503 is not the preset field in S502, since the encrypted Bluetooth data packet includes data of the major field and data of the minor field, the data corresponding to the major field and/or the data corresponding to the minor field may also be acquired from the encrypted Bluetooth data packet.

Optionally, in the case where the major field includes a random field, the validity check value of the encrypted Bluetooth data packet is determined according to the random string corresponding to the random field of the major field. Specifically, the random string corresponding to the random field of the major field may be used as the validity check value of the encrypted Bluetooth data packet. For example, the fixed position (such as the last six bits) of the major field is the random field, and the other positions (such as the other bits other than the last six bits) are the valid field, part or all of strings are extracted from random strings corresponding to the random field and used as the validity check value of the encrypted Bluetooth data packet.

Optionally, in the case where the minor field includes a random field, the validity check value of the encrypted Bluetooth data packet is determined according to the random string corresponding to the random field of the minor field. Specifically, the random string corresponding to the random field of the minor field may be used as the validity check value of the encrypted Bluetooth data packet. For example, the fixed position (such as the first bit) of the minor field is the random field, and the other positions (such as the other bits other than the first bit) are the valid field, part or all of strings are extracted from random strings corresponding to the random field and used as the validity check value of the encrypted Bluetooth data packet.

Optionally, in the case where the major field includes a random field, and the minor field includes a random field, the validity check value of the encrypted Bluetooth data packet is determined according to the random string corresponding to the random field of the major field and the random string corresponding to the random field of the minor field. Specifically, the target string is selected from the random string corresponding to the random field of the major field and the random string corresponding to the random field of the minor field. The target string is used as the validity check value of the encrypted Bluetooth data packet.

For example, part or all of strings may be selected from the random strings corresponding to the random field of the major field and used as the target string. Then, the target string is used as the validity check value of the encrypted Bluetooth data packet.

Alternatively, part or all of strings may be selected from the random strings corresponding to the random field of the minor field and used as the target string. Then, the target string is used as the validity check value of the encrypted Bluetooth data packet.

Alternatively, part or all of strings may be extracted from the random strings corresponding to the random field of the major field and used as the first string, and part or all of strings are extracted from the random strings corresponding to the random field of the minor field and used as the second string. The first string and the second string are spliced to obtain the target string. Then the target string is used as the validity check value of the encrypted Bluetooth data packet. For example, the corresponding string is extracted from the random field (such as the last six bits) of the major field and used as the first string, and the corresponding string is extracted from the random field (such as the first bit) of the minor field and used as the second string. Thereafter, the first string and the second string may be spliced based on a certain splicing rule. For example, the first string is added after the second string to obtain the target string. Then the target string is used as the validity check value of the encrypted Bluetooth data packet.

It is to be understood that the validity check value of the encrypted Bluetooth data packet is determined in different manners, thereby widening the determination method of the validity check value.

In S504, the data ciphertext in the target data of the preset field is decrypted by using the validity check value and the Bluetooth key of the Bluetooth device to obtain the original data of the target data.

In S505, the decrypted Bluetooth data packet is determined based on the original data. Positioning processing is performed based on the decrypted Bluetooth data packet.

In the technical solutions provided by this embodiment of the present disclosure, the encrypted Bluetooth data packet broadcast by the Bluetooth device is received. Thereafter, the target data of the preset field is extracted from the encrypted Bluetooth data packet. Then the validity check of the encrypted Bluetooth data packet is determined based on the random string corresponding to the random field of the major field and/or the random string corresponding to the random field of the minor field, and the data ciphertext in the target data of the preset field is decrypted by using the validity check value and the Bluetooth key of the Bluetooth device to obtain the original data of the target data. Further, the decrypted Bluetooth data packet may be obtained based on the original data. Finally, positioning processing is performed based on the decrypted Bluetooth data packet. In the preceding technical solutions, the validity check value is determined based on the random field of the major field and the random field of the minor field. In one aspect, the determination method of the validity check value is widened, and data support is provided for subsequent decryption of the target data of the preset field. In another aspect, the uniqueness of the validity check value is ensured based on the randomness of a random string, thereby increasing the security of the Bluetooth data packet.

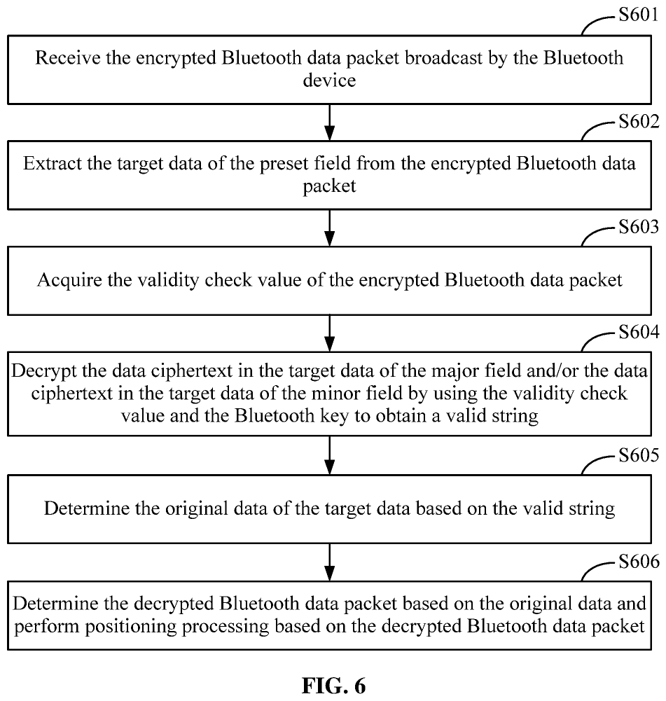

FIG. 6 is a flowchart of another data processing method according to an embodiment of the present disclosure. Based on the preceding embodiments, in the case where the preset field includes a major field and/or a minor field, this embodiment further optimizes the method for the operation of decrypting the data ciphertext in the target data of the preset field by using the validity check value and the Bluetooth key of the Bluetooth device to obtain the original data of the target data and provides an optical solution. As shown in FIG. 6, the data processing method according to this embodiment may include the steps below.

In S601, the encrypted Bluetooth data packet broadcast by the Bluetooth device is received.

In S602, the target data of the preset field is extracted from the encrypted Bluetooth data packet.

The preset field includes at least one of: a MAC address field, a major field, or a minor field.

In S603, the validity check value of the encrypted Bluetooth data packet is acquired.

In S604, the data ciphertext in the target data of the major field and/or the data ciphertext in the target data of the minor field is decrypted by using the validity check value and the Bluetooth key to obtain the valid string.

In S605, the original data of the target data is determined based on the valid string.

In S606, the decrypted Bluetooth data packet is determined based on the original data. Positioning processing is performed based on the decrypted Bluetooth data packet.

In an embodiment, in the case where the preset field is the major field, and the major field includes a random field, the target data of the major field includes a data ciphertext and a random string (that is, unencrypted data). The data ciphertext is data obtained after the valid string corresponding to the valid field of the major field is encrypted.

Alternatively, in the case where the preset field is the major field, and the major field does not include a random field, the target data of the major field is the data ciphertext.

In the two cases, the data ciphertext in the target data of the major field is decrypted based on a preset decryption algorithm by using the validity check value and the Bluetooth key to obtain the valid string. Thereafter, the valid string is used to replace the data ciphertext in the target data to obtain the original data of the target data. Then, the original data of the target data is used to replace the target data of the preset field in the encrypted Bluetooth data packet to obtain the decrypted Bluetooth data packet. Positioning processing is performed based on the decrypted Bluetooth data packet.

In another embodiment, in the case where the preset field is the minor field, and the minor field includes a random field, the target data of the minor field includes a data ciphertext and a random string. The data ciphertext is data obtained after the valid string corresponding to the valid field of the minor field is encrypted.

Alternatively, in the case where the preset field is the minor field, and the minor field does not include a random field, the target data in the minor field is the data ciphertext.

In the two cases, the data ciphertext in the target data of the minor field is decrypted based on the preset decryption algorithm by using the validity check value and the Bluetooth key to obtain the valid string. Thereafter, the valid string is used to replace the data ciphertext in the target data to obtain the original data of the target data. Then, the original data of the target data is used to replace the target data of the preset field in the encrypted Bluetooth data packet to obtain the decrypted Bluetooth data packet. Positioning processing is performed based on the decrypted Bluetooth data packet.

In another optional embodiment, in the case where the preset field is the major field and the minor field, the major field includes a random field, and the minor field does not include a random field, the target data of the major field includes a data ciphertext and a random string (that is, unencrypted data), and the target data in the minor field is a data ciphertext.

Alternatively, in the case where the preset field is the major field and the minor field, the minor field includes a random field, and the major field does not include a random field, the target data of the minor field includes a data ciphertext and a random string (that is, unencrypted data), and the target data in the major field is a data ciphertext.

Alternatively, in the case where the preset field is the major field and the minor field, the major field includes a random field, and the minor field includes a random field, the target data of the major field includes a data ciphertext and a random string (that is, unencrypted data), and the target data of the minor field includes a data ciphertext and a random string (that is, unencrypted data).

In the three cases, the data ciphertext in the target data of the major field is decrypted based on the preset decryption algorithm by using the validity check value and the Bluetooth key to obtain the valid string of the major field. The data ciphertext in the target data of the minor field is decrypted to obtain the valid string of the minor field. Thereafter, the valid string of the major field is used to replace the data ciphertext in the target data of the major field to obtain the original data of the target data of the major field. The valid string of the minor field is used to replace the data ciphertext in the target data of the minor field to obtain the original data of the target data of the minor field. Then, the original data of the target data of the major field and the original data of the target data of the minor field are used to update the encrypted Bluetooth data packet to obtain the decrypted Bluetooth data packet. Positioning processing is performed based on the decrypted Bluetooth data packet.

In the technical solutions provided by this embodiment of the present disclosure, the encrypted Bluetooth data packet broadcast by the Bluetooth device is received. Thereafter, the target data of the preset field is extracted from the encrypted Bluetooth data packet. Then, the validity check value of the encrypted Bluetooth data packet is acquired, and the data ciphertext in the target data of the major field and/or the data ciphertext in the target data of the minor field is decrypted by using the validity check value and the Bluetooth key to obtain the valid string. Further, the valid string is used to update the encrypted Bluetooth data packet to obtain the decrypted Bluetooth data packet. Finally, positioning processing is performed based on the decrypted Bluetooth data packet. In the preceding technical solutions, the data ciphertexts of the target data of different preset fields are dynamically decrypted, so that the decryption method of the Bluetooth data packet is widened.

On the basis of the preceding embodiments, in an optional method of the present disclosure, in the case where the preset field includes a MAC address field, the data ciphertext in the target data of the preset field may be decrypted by using the validity check value and the Bluetooth key of the Bluetooth device to obtain the original data of the target data in the following manner: The data ciphertext in the target data of the MAC address field is decrypted by using the validity check value and the Bluetooth key to obtain the original data of the target data.

Specifically, the Bluetooth key and the validity check value may be used to decrypt the data ciphertext in the target data of the MAC address field based on the preset decryption algorithm to obtain the original data of the target data.

Further, the original data of the target data is used to replace the target data of the MAC field in the Bluetooth data packet to obtain the decrypted Bluetooth data packet.

It is to be understood that in this embodiment, the target data of the MAC address field may be decrypted, so that the data decryption method of the Bluetooth data packet is further widened.

On the basis of the preceding embodiments, in an optional method of the present disclosure, in the case where the preset field includes a MAC address field, a major field, and/or a minor field, the data ciphertext in the target data of the MAC address field is decrypted based on the preset decryption algorithm by using the validity check value and the Bluetooth key to obtain the original data of the target data. At the same time, the data ciphertext in the target data of the major field and/or the data ciphertext in the target data of the minor field is decrypted by using the validity check value and the Bluetooth key to obtain the valid string. Thereafter, the original data of the target data of a corresponding field is determined based on the valid string.

Thereafter, the data ciphertext of the target data of the corresponding field in the encrypted Bluetooth data packet is updated based on the original data of the target data of the corresponding field to obtain the decrypted Bluetooth data packet. The specific process is described in the preceding embodiments, and the details are not repeated here.

On the basis of the preceding embodiments, a preferred embodiment is provided. The process in which the Bluetooth device and the mobile terminal encrypt and decrypt a Bluetooth data packet is described in detail.

In a first part, the process in which the Bluetooth device encrypts the Bluetooth data packet is described below.

The original data of the preset field is extracted from the to-be-broadcast Bluetooth data packet. For example, the preset field is the MAC field, the major field, and the minor field. The original data corresponding to the major field includes 16-bit data. The original data corresponding to the minor field includes 16-bit data. Further, the last 6 bits of the major field is a random field, and the remaining 10 bits is a valid field. The first bit of the minor field is a random field, and the remaining 15 bits is a valid field.

Thereafter, the random string of the random field (the last 6 bits) of the major field is spliced to the random string of the random field (the first bit) of the minor field, and a 7-bit random string is obtained. The random string is used as the validity check value.

Then, the valid check value and the Bluetooth key are used to encrypt the valid string corresponding to the valid field of the major field, the valid string corresponding to the valid field of the minor field, and the original data of the MAC address field.

Thereafter, the data obtained after the valid string corresponding to the valid field of the major field is encrypted is used to replace the valid string corresponding to the valid field of the major field in the to-be-broadcast Bluetooth data packet. The data obtained after the valid string corresponding to the valid field of the minor field is encrypted is used to replace the valid string corresponding to the valid field of the minor field in the to-be-broadcast Bluetooth data packet. The data obtained after the original data corresponding to the MAC address field is encrypted is used to replace the original data corresponding to the MAC address field in the to-be-broadcast Bluetooth data packet. In this manner, the encrypted Bluetooth data packet is obtained, and the encrypted Bluetooth data packet is broadcast.

In a second part, the process in which the mobile terminal receives the encrypted Bluetooth data packet broadcast by the Bluetooth device and decrypts the encrypted Bluetooth data packet is described below.

The validity check value is acquired from the encrypted Bluetooth data packet in the same manner as the Bluetooth device acquires the validity check value.

Thereafter, the data ciphertext corresponding to the valid field of the major field is decrypted by using the validity check value and the Bluetooth key of the Bluetooth device to obtain the valid string of the major field. The data ciphertext corresponding to the valid field of the minor field is decrypted by using the validity check value and the Bluetooth key of the Bluetooth device to obtain the valid string of the minor field. The target data corresponding to the MAC address field is decrypted by using the validity check value and the Bluetooth key of the Bluetooth device to obtain the original data of a MAC address (that is, a real MAC address).

Finally, the valid string corresponding to the major field is used to replace the data ciphertext corresponding to the major field in the encrypted Bluetooth data packet. The valid string corresponding to the minor field is used to replace the data ciphertext corresponding to the minor field in the encrypted Bluetooth data packet. The original data of the MAC address is used to replace the target data corresponding to the MAC address field in the encrypted Bluetooth data packet. In this manner, the decrypted Bluetooth data packet is obtained, and positioning processing is performed based on the decrypted Bluetooth data packet.

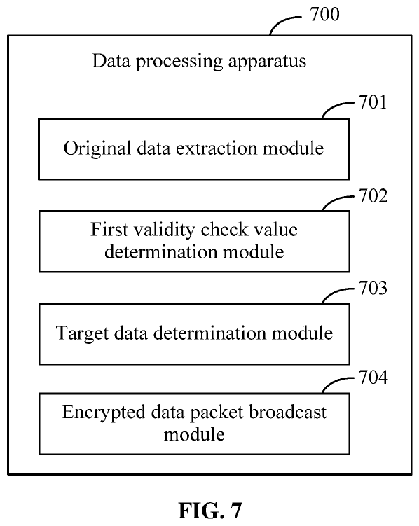

FIG. 7 is a diagram illustrating the structure of a data processing apparatus according to an embodiment of the present disclosure. This embodiment is applicable to the case where the Bluetooth data packet is encrypted in the Bluetooth positioning scenario to prevent the Bluetooth device from being piggybacked on. This apparatus may be performed by software and/or hardware and may be integrated into the electronic device carrying the data processing function, such as the Bluetooth device. As shown in FIG. 7, the data processing apparatus 700 according to this embodiment may include an original data extraction module 701, a first validity check value determination module 702, a target data determination module 703, and an encrypted data packet broadcast module 704.

The original data extraction module 701 is configured to extract the original data of the preset field from the to-be-broadcast Bluetooth data packet. The preset field includes at least one of: a MAC address field, a Bluetooth major identifier field, or a Bluetooth minor identifier field.

The first validity check value determination module 702 is configured to acquire the validity check value of the to-be-broadcast Bluetooth data packet.

The target data determination module 703 is configured to encrypt the original data of the preset field by using the validity check value and the Bluetooth key to obtain the target data of the original data. The target data includes a data ciphertext.

The encrypted data packet broadcast module 704 is configured to determine the encrypted Bluetooth data packet based on the target data and broadcast the encrypted Bluetooth data packet.

In the technical solutions provided by this embodiment of the present disclosure, the original data of the preset field is extracted from the to-be-broadcast Bluetooth data packet. Thereafter, the validity check value of the to-be-broadcast Bluetooth data packet is acquired. Then, the original data of the preset field is encrypted by using the validity check value and the Bluetooth key to obtain the target data including the data ciphertext. Further, the encrypted Bluetooth data packet may be obtained based on the target data, and the encrypted Bluetooth data packet is broadcast. In the preceding technical solutions, on the premise that the reception of the Bluetooth data packet by the mobile terminal is not affected, the data corresponding to the preset field is encrypted to encrypt the to-be-broadcast Bluetooth data packet. In this manner, the problem that a deployed Bluetooth device is piggybacked on is solved. At the same time, the case where other Bluetooth devices having the same preset field data content as the data content of the deployed Bluetooth device maliciously interferes with the positioning effect can be avoided.

Further, the major field includes a random field, and/or the minor field includes a random field.

Further, the first validity check value determination module 702 is configured to determine the validity check value of the to-be-broadcast Bluetooth data packet according to the random string corresponding to the random field of the major field and/or the random string corresponding to the random field of the minor field.

Further, the first validity check value determination module 702 is also configured to select the target string from the random string corresponding to the random field of the major field and the random string corresponding to the random field of the minor field and use the target string as the validity check value of the to-be-broadcast Bluetooth data packet.

Further, the target data determination module 703 is configured to encrypt the valid string in the original data of the major field and/or the valid string in the original data of the minor field by using the validity check value and the Bluetooth key to obtain the data ciphertext and determine the target data of the original data based on the data ciphertext.

Further, the target data determination module 703 is configured to encrypt the original data of the MAC address field by using the validity check value and the Bluetooth key to obtain the data ciphertext and determine the target data of the original data based on the data ciphertext.

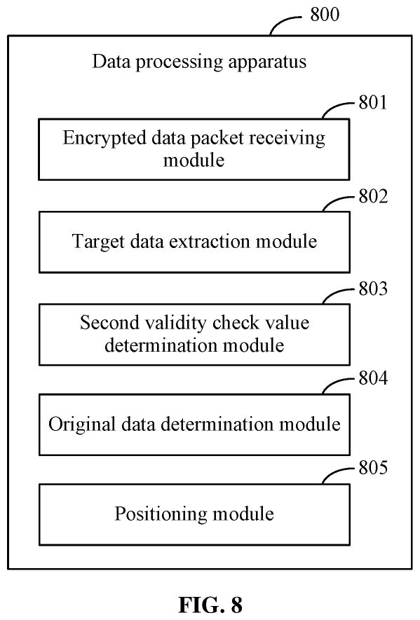

FIG. 8 is a diagram illustrating the structure of another data processing apparatus according to an embodiment of the present disclosure. This embodiment is applicable to how to perform positioning based on the encrypted Bluetooth data packet in the Bluetooth positioning scenario. The encrypted Bluetooth data packet may be obtained by the Bluetooth device based on the data processing method provided in any one of the preceding embodiments. This apparatus may be performed by software and/or hardware and may be integrated into the electronic device carrying the data processing function, such as the mobile terminal. As shown in FIG. 8, the data processing apparatus 800 according to this embodiment may include an encrypted data packet receiving module 801, a target data extraction module 802, a second validity check value determination module 803, an original data determination module 804, and a positioning module 805.

The encrypted data packet receiving module 801 is configured to receive the encrypted Bluetooth data packet broadcast by the Bluetooth device.

The target data extraction module 802 is configured to extract the target data of the preset field from the encrypted Bluetooth data packet. The preset field includes at least one of: a MAC address field, a major field, or a minor field. The target data includes a data ciphertext.

The second validity check value determination module 803 is configured to acquire the validity check value of the encrypted Bluetooth data packet.

The original data determination module 804 is configured to decrypt the data ciphertext in the target data of the preset field by using the validity check value and the Bluetooth key of the Bluetooth device to obtain the original data of the target data.

The positioning module 805 is configured to determine the decrypted Bluetooth data packet based on the original data and perform positioning processing based on the decrypted Bluetooth data packet.

In the technical solutions provided by this embodiment of the present disclosure, the encrypted Bluetooth data packet broadcast by the Bluetooth device is received. Thereafter, the target data of the preset field is extracted from the encrypted Bluetooth data packet. Then, the validity check value of the encrypted Bluetooth data packet is acquired, and the data ciphertext in the target data of the preset field is decrypted by using the validity check value and the Bluetooth key of the Bluetooth device to obtain the original data of the target data. Further, the decrypted Bluetooth data packet may be obtained based on the original data. Finally, positioning processing is performed based on the decrypted Bluetooth data packet. In the preceding technical solutions, on the premise that the reception of the Bluetooth data packet by the mobile terminal is not affected, the data corresponding to the preset field is encrypted to encrypt the to-be-broadcast Bluetooth data packet. In this manner, the problem that a deployed Bluetooth device is piggybacked on is solved. At the same time, the case where other Bluetooth devices having the same preset field data content as the data content of the deployed Bluetooth device maliciously interferes with the positioning effect can be avoided.

Further, the major field includes a random field, and/or the minor field includes a random field.

Further, the second validity check value determination module 803 is configured to determine the validity check value of the encrypted Bluetooth data packet according to the random string corresponding to the random field of the major field and/or the random string corresponding to the random field of the minor field.

Further, the second validity check value determination module 803 is also configured to select the target string from the random string corresponding to the random field of the major field and the random string corresponding to the random field of the minor field and use the target string as the validity check value of the encrypted Bluetooth data packet.

Further, the original data determination module 804 is configured to decrypt the data ciphertext in the target data of the major field and/or the data ciphertext in the target data of the minor field by using the validity check value and the Bluetooth key to obtain the valid string and determine the original data of the target data based on the valid string.

Further, the original data determination module 804 is configured to decrypt the data ciphertext in the target data of the MAC address field by using the validity check value and the Bluetooth key to obtain the original data of the target data.

Operations, including acquisition, storage, and application, on a Bluetooth data packet involved in the solution of the present disclosure conform to relevant laws and regulations and do not violate the public policy doctrine.

According to an embodiment of the present disclosure, the present disclosure also provides an electronic device, a readable storage medium, and a computer program product.

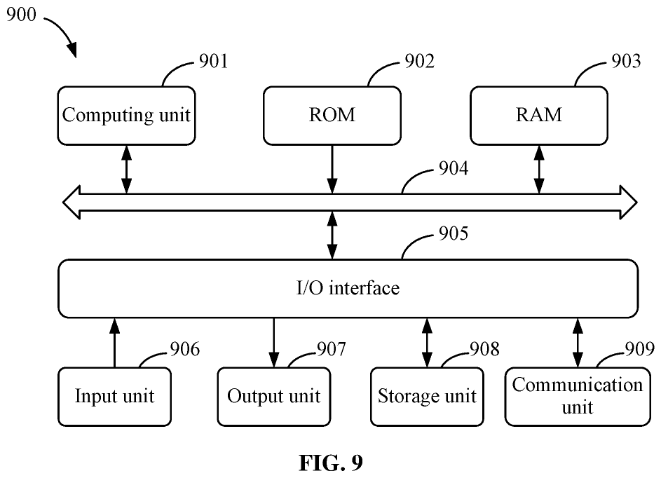

FIG. 9 is a block diagram of an electronic device for implementing a data processing method according to an embodiment of the present disclosure. FIG. 9 is a block diagram of an example electronic device 900 that may be configured to implement this embodiment of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 9, the electronic device 900 includes a computing unit 901. The computing unit 901 may perform various appropriate actions and processing according to a computer program stored in a read-only memory (ROM) 902 or a computer program loaded into a random-access memory (RAM) 903 from a storage unit 908. Various programs and data required for the operation of the electronic device 900 are also stored in the RAM 903. The computing unit 901, the ROM 902, and the RAM 903 are connected to each other through a bus 904. An input/output (I/O) interface 905 is also connected to the bus 904.

Multiple components in the electronic device 900 are connected to the I/O interface 905. The multiple components include an input unit 906 such as a keyboard or a mouse, an output unit 907 such as various types of displays or speakers, the storage unit 908 such as a magnetic disk or an optical disk, and a communication unit 909 such as a network card, a modem or a wireless communication transceiver. The communication unit 909 allows the electronic device 900 to exchange information/data with other devices over a computer network such as the Internet and/or various telecommunications networks.

The computing unit 901 may be various general-purpose and/or special-purpose processing components having processing and computing capabilities. Examples of the computing unit 901 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 901 performs various methods and processing described above, such as the data processing method. For example, in some embodiments, the data processing method may be implemented as a computer software program tangibly contained in a machine-readable medium such as the storage unit 908. In some embodiments, part or all of computer programs may be loaded and/or installed onto the electronic device 900 via the ROM 902 and/or the communication unit 909. When the computer program is loaded to the RAM 903 and executed by the computing unit 901, one or more steps of the preceding data processing method may be executed. Alternatively, in other embodiments, the computing unit 901 may be configured, in any other suitable manner (for example, by means of firmware), to execute the data processing method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, a server of a distributed system, or a server combined with a blockchain.

Artificial intelligence is the study of making computers simulate certain human thinking processes and intelligent behaviors (such as learning, reasoning, thinking and planning) both at the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

Cloud computing refers to a technical system that accesses a shared elastic-and-scalable physical or virtual resource pool through a network, where resources may include servers, operating systems, networks, software, applications, and storage devices and may be deployed and managed in an on-demand and self-service manner. Cloud computing can provide efficient and powerful data processing capabilities for artificial intelligence, the blockchain, and other technical applications and model training.

It is to be understood that various forms of the preceding flows may be used with steps reordered, added, or removed. For example, the steps described in the present disclosure may be executed in parallel, in sequence, or in a different order as long as the desired results of the technical solutions disclosed in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A data processing method, comprising:
extracting original data of a preset field from a to-be-broadcast Bluetooth data packet, wherein the preset field comprises at least one of: a media access control (MAC) address field, a Bluetooth major identifier field, or a Bluetooth minor identifier field;
acquiring a validity check value of the to-be-broadcast Bluetooth data packet;
encrypting the original data of the preset field by using the validity check value and a Bluetooth key to obtain target data of the original data, wherein the target data comprises a data ciphertext; and
determining an encrypted Bluetooth data packet based on the target data and broadcasting the encrypted Bluetooth data packet.

2. The method according to claim 1, wherein at least one of the major field and the minor field comprises a random field.

3. The method according to claim 2, wherein the acquiring the validity check value of the to-be-broadcast Bluetooth data packet comprises:
determining the validity check value of the to-be-broadcast Bluetooth data packet according to a random string corresponding to the random field of the major field and/or a random string corresponding to the random field of the minor field.

4. The method according to claim 3, wherein the determining the validity check value of the to-be-broadcast Bluetooth data packet according to the random string corresponding to the random field of the major field and the random string corresponding to the random field of the minor field comprises:
selecting a target string from the random string corresponding to the random field of the major field and the random string corresponding to the random field of the minor field; and
configuring the target string as the validity check value of the to-be-broadcast Bluetooth data packet.

5. The method according to claim 3, wherein the encrypting the original data of the preset field by using the validity check value and the Bluetooth key to obtain the target data of the original data comprises:
encrypting a valid string in original data of the major field and a valid string in original data of the minor field by using the validity check value and the Bluetooth key to obtain the data ciphertext; and
determining the target data of the original data based on the data ciphertext.

6. The method according to claim 3, wherein the encrypting the original data of the preset field by using the validity check value and the Bluetooth key to obtain the target data of the original data comprises:
encrypting a valid string in original data of the major field or a valid string in original data of the minor field by using the validity check value and the Bluetooth key to obtain the data ciphertext; and
determining the target data of the original data based on the data ciphertext.

7. The method according to claim 3, wherein the encrypting the original data of the preset field by using the validity check value and the Bluetooth key to obtain the target data of the original data comprises:
encrypting original data of the MAC address field by using the validity check value and the Bluetooth key to obtain the data ciphertext; and
determining the target data of the original data based on the data ciphertext.

8. A data processing method, comprising:
receiving an encrypted Bluetooth data packet broadcast by a Bluetooth device;
extracting target data of a preset field from the encrypted Bluetooth data packet, wherein the preset field comprises at least one of: a MAC address field, a major field, or a minor field, and the target data comprises a data ciphertext;
acquiring a validity check value of the encrypted Bluetooth data packet;
decrypting the data ciphertext in the target data by using the validity check value and a Bluetooth key of the Bluetooth device to obtain original data of the target data; and
determining a decrypted Bluetooth data packet based on the original data and performing positioning processing based on the decrypted Bluetooth data packet.

9. The method according to claim 8, wherein at least one of the major field and the minor field comprises a random field.

10. The method according to claim 9, wherein the acquiring the validity check value of the encrypted Bluetooth data packet comprises:
determining the validity check value of the encrypted Bluetooth data packet according to a random string corresponding to the random field of the major field and a random string corresponding to the random field of the minor field.

11. The method according to claim 9, wherein the acquiring the validity check value of the encrypted Bluetooth data packet comprises:
determining the validity check value of the encrypted Bluetooth data packet according to a random string corresponding to the random field of the major field or a random string corresponding to the random field of the minor field.

12. The method according to claim 10, wherein determining the validity check value of the encrypted Bluetooth data packet according to the random string corresponding to the random field of the major field and the random string corresponding to the random field of the minor field comprises:
selecting a target string from the random string corresponding to the random field of the major field and the random string corresponding to the random field of the minor field; and
configuring the target string as the validity check value of the encrypted Bluetooth data packet.

13. The method according to claim 10, wherein decrypting the data ciphertext in the target data by using the validity check value and the Bluetooth key of the Bluetooth device to obtain the original data of the target data comprises:
decrypting a data ciphertext in target data of the major field and a data ciphertext in target data of the minor field by using the validity check value and the Bluetooth key to obtain a valid string; and
determining the original data of the target data based on the valid string.

14. The method according to claim 10, wherein decrypting the data ciphertext in the target data by using the validity check value and the Bluetooth key of the Bluetooth device to obtain the original data of the target data comprises:
decrypting a data ciphertext in target data of the major field or a data ciphertext in target data of the minor field by using the validity check value and the Bluetooth key to obtain a valid string; and
determining the original data of the target data based on the valid string.

15. The method according to claim 10, wherein decrypting the data ciphertext in the target data by using the validity check value and the Bluetooth key of the Bluetooth device to obtain the original data of the target data comprises:
decrypting a data ciphertext in target data of the MAC address field by using the validity check value and the Bluetooth key to obtain the original data of the target data.

16. An electronic device, comprising:
at least one processor; and
a memory communicatively connected to the at least one processor,
wherein the memory stores instructions executable by the at least one processor to enable the at least one processor to execute a data processing method, wherein the data processing method comprises:
extracting original data of a preset field from a to-be-broadcast Bluetooth data packet, wherein the preset field comprises at least one of: a media access control (MAC) address field, a Bluetooth major identifier field, or a Bluetooth minor identifier field;
acquiring a validity check value of the to-be-broadcast Bluetooth data packet;
encrypting the original data of the preset field by using the validity check value and a Bluetooth key to obtain target data of the original data, wherein the target data comprises a data ciphertext; and
determining an encrypted Bluetooth data packet based on the target data and broadcasting the encrypted Bluetooth data packet.

17. The electronic device according to claim 16, wherein at least one of the major field and the minor field comprises a random field.

18. The electronic device according to claim 17, wherein the acquiring the validity check value of the to-be-broadcast Bluetooth data packet comprises:
determining the validity check value of the to-be-broadcast Bluetooth data packet according to a random string corresponding to the random field of the major field and a random string corresponding to the random field of the minor field.

19. The electronic device according to claim 18, wherein the determining the validity check value of the to-be-broadcast Bluetooth data packet according to the random string corresponding to the random field of the major field and the random string corresponding to the random field of the minor field comprises:
selecting a target string from the random string corresponding to the random field of the major field and the random string corresponding to the random field of the minor field; and
configuring the target string as the validity check value of the to-be-broadcast Bluetooth data packet.

20. A non-transitory computer-readable storage medium storing computer instructions for causing a computer to execute the data processing method according to claim 1.
